(19) United States
(12) Patent Application Publication
(10) Pub. No.: US 2007/0245112 A1
(43) Pub. Date: Oct. 18, 2007

(54) Mapping between a file system and logical log volume

(76) Inventors: Mark Allen Grubbs, Round Rock, TX (US); Gerald Francis McBrearty, Austin, TX (US); Grover Herbert Neuman, Austin, TX (US)

Correspondence Address: IBM CORP (YA);C/O YEE & ASSOCIATES PC, P.O. BOX 802333, DALLAS, TX, 75380, US

(21) Appl. No.: 11/406,183

(22) Filed: Apr. 18, 2006

(51) Int. Cl. G06F 12/00

(52) U.S. Cl. 711/170

(57) ABSTRACT

A computer implemented method, data processing system, and computer usable code are provided for mapping between a file system and a log. Opaque data is generated that identifies a location of the file system and a location of the log. The file system and the log are accessed using this opaque data. An opaque identifier is associated with the opaque data, which is then sent to the file system and the log. When a log access request, which includes the opaque identifier, is received from the file system, the location of the log is identified using the opaque identifier and the file system is directed to the location of the log. When a logredo request, which includes the opaque identifier, is received from the log, the file system location is identified using the opaque identifier and the log is directed to the location of the file system.

### BACKGROUND OF THE INVENTION

1. Field of the Invention

The present invention relates generally to information systems technology. More particularly, the present application relates to the storage of information in a computer system. Still more particularly, the present application relates to mapping between a file system and a logical log volume.

2. Description of the Related Art

The purpose of a file system is simply to hold data. UNIX® file systems have had a fairly common evolution which eventually became the UNIX® industry standard known as the UNIX File System (UFS). IBM® introduced its UNIX® file system as the Journaled File System (JFS) with the initial release of Advanced Interactive Executive (AIX®). IBM® then introduced a second file system that is to run on AIX® systems called Enhanced Journaled File System (JFS2), which is available in later versions of AIX®. Veritas™ introduced the Veritas File System™ (VxFS) that is sold to run as a standalone product, or with Veritas Volume Manager™ (VxVM) or other volume managers. VxFS can optimize input/output (I/O) and is designed to work with standard volume managers. JFS and JFS2 are designed to run on the AIX® Logical Volume Manager (LVM) that is built into the base of the AIX® operating system.

A key aspect of any file system is how to recover if the system experiences a system crash. The earlier method, requiring a scan of the entire file system, is time-consuming, and can be a waste of time because only a small portion of the file system requires cleanup after a crash. A solution to this problem is a method of journaling or logging the metadata of files. Metadata is everything concerning a file except the actual data inside the file. Elements of the file, such as its physical location and size, are tracked by the metadata. With logging, whenever something changes in the metadata of a file, this new attribute information will be logged into a reserved area of the file system. Only after the write of the metadata to the log is complete, will the file system actually write the data to the disk platter. If, and when, a system crash occurs, the system recovery code will analyze the metadata log and try to clean up only those files. Typical cleanup on UNIX® systems is through the file system check command.

There are internal and external logs. An internal log is the metadata log incorporated into the same physical location as the file system itself. An external log need not be tied to the same disk or physical location as the reserved areas of a file system. Administrators may want the external logs on standalone disks to help improve write throughput, because a write to a file system log must take effect before the actual data write to the file system. Performance is improved because the disk heads are not going to move between the log and the rest of the file system. By default, JFS and JFS2 use external logs.

However, file systems may move from machine to machine, which is common with AIX®. With file systems moving and the external log being on a different storage device, mapping of the files system to the external log becomes tedious and time consuming.

### SUMMARY OF THE INVENTION

The different aspects of the illustrative embodiments provide a computer implemented method, data processing system, and computer usable code for mapping between a file system and a log. A first volume group is provided that comprises a logical volume stored in physical disk locations. Opaque data is generated that identifies a location of the file system and a location of the log within the logical volume. The file system and the log are accessed using the opaque data. A request from the file system initiates the creation of the log and then the log is created on the logical volume. An opaque identifier is associated with the opaque data, which is then sent to the file system and the log. Upon receipt of a log access request from the file system that includes the opaque identifier, the location of the log is identified using the opaque identifier and the file system is directed to the location of the log. Upon a receipt of a logredo request from the log that includes the opaque identifier, the file system location is identified using the opaque identifier and the log is directed to the location of the file system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the illustrative embodiments may be implemented;

FIG. 2 depicts a block diagram of a data processing system in which aspects of the illustrative embodiments may be implemented;

FIG. 3 illustrates a file system and log storage arrangement in accordance with an illustrative embodiment;

FIG. 4 depicts a flow diagram of creating a log in accordance with an illustrative embodiment;

FIG. 5 depicts a flow diagram of a file system requesting access to a log in accordance with an illustrative embodiment; and

FIG. 6 depicts a flow diagram of synchronization a log to a file system in accordance with an illustrative embodiment.

### DETAILED DESCRIPTION OF THE PREFERRED EMBODIMENT

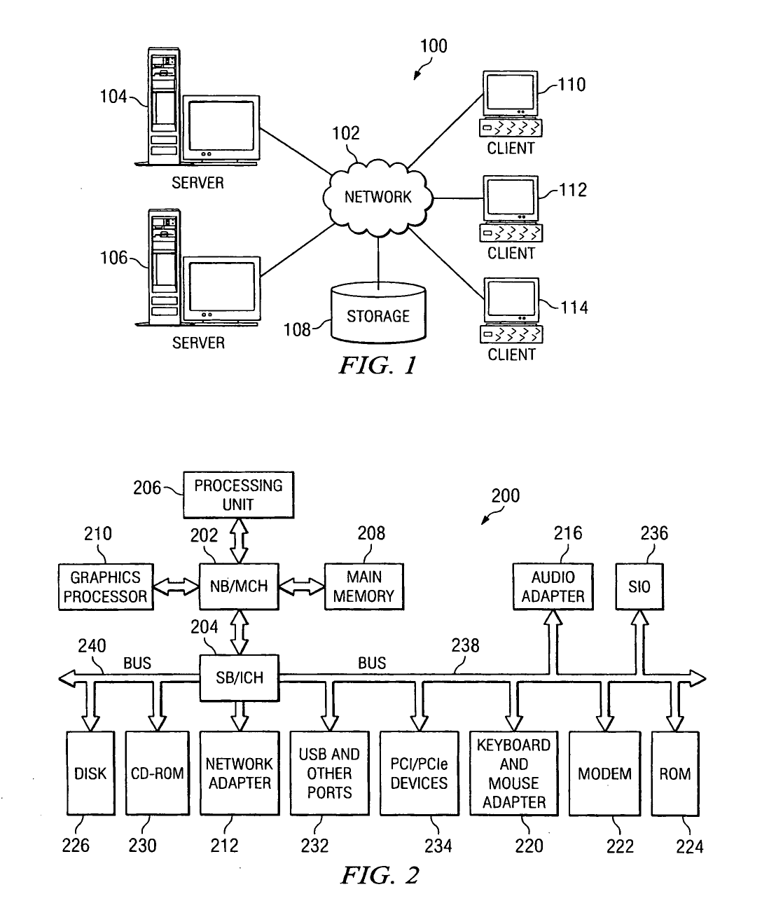

The illustrative embodiments provide for a mapping system using any number of volume groups when a log is created. With reference now to the figures and in particular with reference to FIGS. 1-2, exemplary diagrams of data processing environments are provided in which the illustrative embodiments may be implemented. It should be appreciated that FIGS. 1-2 are only exemplary and are not intended to assert or imply any limitation with regard to the environments in which the aspects of the illustrative embodiments may be implemented. Many modifications to the depicted environments may be made without departing from the spirit and scope of the illustrative embodiments.

With reference now to the figures, FIG. 1 depicts a pictorial representation of a network of data processing systems in which aspects of the illustrative embodiments may be implemented. Network data processing system 100 is a network of computers in which embodiments of the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the illustrative embodiments.

With reference now to FIG. 2, a block diagram of a data processing system is shown in which aspects of the illustrative embodiments may be implemented. Data processing system 200 is an example of a computer, such as server 104 or client 110 in FIG. 1, in which computer usable code or instructions implementing the processes for embodiments of the illustrative embodiments may be located.

In the depicted example, data processing system 200 employs a hub architecture including north bridge and memory controller hub (NB/MCH) 202 and south bridge and input/output (I/O) controller hub (SB/ICH) 204. Processor unit 206, main memory 208, and graphics processor 210 are connected to north bridge and memory controller hub 202. Processor unit 206 contains a set of one or more processors. When more than one processor is present, these processors may be separate processors in separate packages. Alternatively, the processors may be multiple cores in a package. Further, the processors may be multiple multi-core units.

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processor unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processor unit 206. Alternatively, a single processor system may be employed.

Instructions for the operating system, the object-oriented programming system, and applications or programs are located on storage devices, such as HDD 226, and may be loaded into main memory 208 for execution by processor unit 206. The processes for embodiments of the illustrative embodiments are performed by processor unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations.

The illustrative embodiments provide a mapping system for mapping between a file system and a log. A volume manager helper generates opaque data that identifies a location of the file system and a location of the log within the logical volume. The file system and the log are then accessed using this opaque data. An opaque identifier is associated with the opaque data, which is then sent to the file system and the log. When a log access request, which includes the opaque identifier, is received from the file system, the location of the log is identified by the volume manager helper using the opaque identifier and the file system is directed to the location of the log. When a logredo (log synchronization) request, which includes the opaque identifier, is received from the log, the file system location is identified using the opaque identifier and the log is directed to the location of the file system.

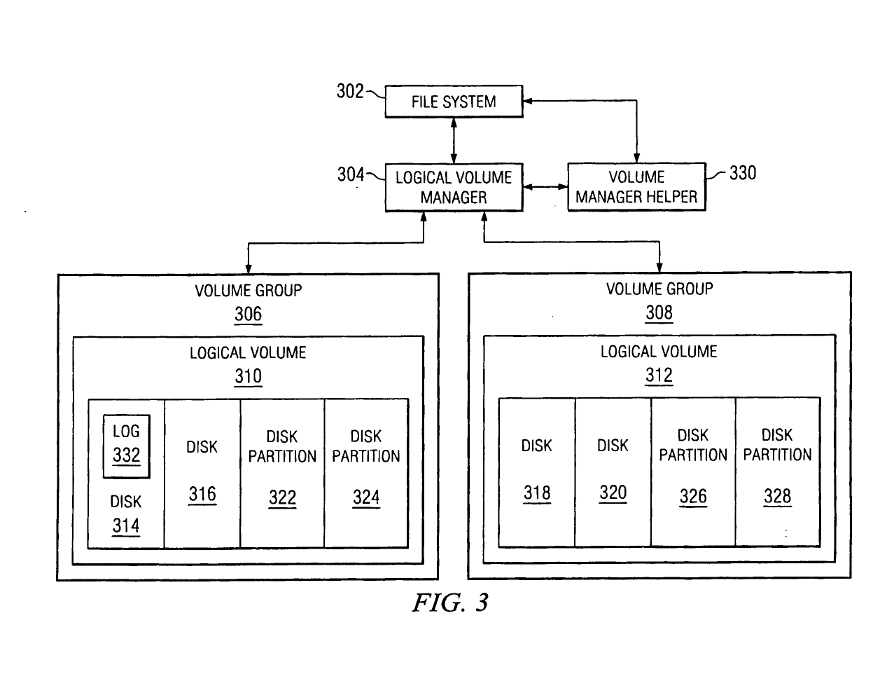

FIG. 3 illustrates a file system and log storage arrangement in accordance with an illustrative embodiment. FIG. 3 depicts file system 302 which uses logical volume manager 304 to access volume groups 306 and 308. File system 302 provides a user with a hierarchical view of the space available for application and data storage. Generally the view is organized as a tree structure of directories for organizational convenience. Operating system commands are provided to open, close, read, write, and control files within the structure. File system 302 uses logical volume manager 304, which in turn uses device drivers to access the hardware, such as volume groups 306 and 308.

Logical volume manager 304 consists of a set of operating system commands, library subroutines, and other tools that allow logical volumes, such as logical volumes 310 and 312 to be established and controlled on volume groups 306 and 308. The operating system commands use the library subroutines to perform management and control tasks for the logical volumes, physical volumes, and volume groups in a system. Volume groups 306 and 308 are a collection of one or more physical volumes each. When physical volumes are created, they must be added to a volume group in order to be used. A physical volume can only be in one volume group on a system, though there can be multiple volume groups, as shown by volume groups 306 and 308. Volume group information includes a unique Volume Group Identifier (VGid), and the PVids of all physical volumes in the volume group, as well as various status information. Each disk, such as disks 314, 316, 318, and 320, in volume groups 306 and 308 respectively, have an area on disk known as the Volume Group Descriptor Area (VGDA), where this information is stored. The Volume Group Descriptor Area also contains information describing all of the logical volumes, such as logical volumes 310 and 312, which exist in the volume group.

If a number of physical volumes are attached to a system or if different file system information is to be accessed, then more than one volume group will definitely be required, as shown by volume groups 306 and 308. It is usually sensible to design the system such that different types of information are stored in different volume groups; however, a logical volume may be able to handle multiple file systems. For example, operating system information contained in one volume group, and user information in a separate one, can assist in management and in particular recovery; should a disk fault occur in a physical volume from one volume group, then only information from that volume group will be affected. As another example, AIX® information may be stored on volume group 306, and Veritas® information stored on volume group 308. As an additional example, both AIX® information and Veritas® information may be located on logical volume 310 within volume group 306.

Once a volume group, such as volume group 306 or 308, has been created, and physical volumes added to it, logical volumes may be created, such as logical volumes 310 and 312. Logical volumes 310 and 312 define a number of logical disk partitions, such as disk partitions 322, 324, 326, and 328, and, therefore, an area of disk that can be used to store information. Logical volumes 310 and 312 are used to store such things as file systems, log volumes, page space, boot data, and dump storage.

Since file system 302 may move from machine to machine, such as from client 110 to client 112 of FIG. 1, which is common with AIX®, mapping of the files system to the external log, which may be stored on server 104 or 106 of FIG. 1, becomes tedious and time consuming. To assist with mapping of a file system to a particular external log, this illustrative embodiment uses volume manager helper 330. Although volume manager helper 330 is shown as a separate component, volume manager helper 330 may be part of logical volume manager 304 or file system 302. When file system 302 creates a log to be stored on, for example, log 332 on disk 314 of logical volume 310 in volume group 306, volume manager helper 330 is invoked to import the specific information about file system 302 and log 332 to create opaque data. The specific information used by volume manager helper 330 may be either a device name, device number, or both of file system 302 and log 332. Volume manager helper 330 creates opaque data that identifies the mapping between file system 302 and log 332. Volume manager helper 330 may then associate an opaque identifier to the mapping which is then sent to file system 302 and log 332.

The next time file system 302 requests access to log 332, the request includes the opaque identifier. The opaque identifier portion of the request is sent to volume manager helper 330, where the opaque identifier is deciphered and the location of log 332 is returned so that file system 302 is able to access the exact location of the log. Likewise, if a logredo is requested, which is a synchronization of log data to a file system, the logredo request includes the opaque identifier. The opaque identifier portion of the request is sent to volume manager helper 330, where the opaque identifier is deciphered and the location of file system 302 is returned so that log 332 is able to access the exact location of file system 302.

If at any time, file system 302 or log 332 are moved, thus changing locations, an update request need only be sent to volume manager helper 330 using the opaque identifier and identifying the new location of either file system 302 or log 332. For example, if log 332 were moved from disk 314 to disk 316, or logical volume 310 to logical volume 312, the updated information does not need to be sent to file system 302 as the opaque data in volume manager helper 330 will be updated with the new location using the opaque identifier.

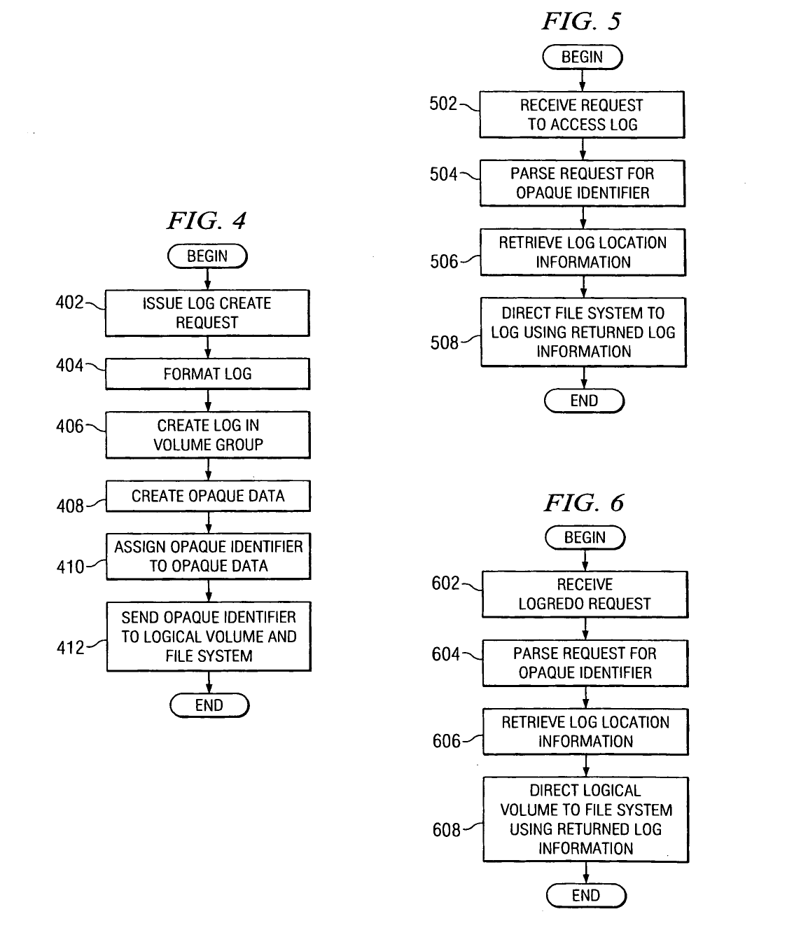

FIG. 4 depicts a flow diagram of creating a log in accordance with an illustrative embodiment. As the operation begins, a file system, such as file system 302 of FIG. 3, issues a log create command (step 402). The file system formats the log in accordance with the formatting of the disk, logical volume, and volume group where the log will be stored, such as on disk 314 of logical volume 310 in volume group 306 of FIG. 3 (step 404). The file system formats the log so that the log data is compliant with only that log creating file system. For example, an AIX® file system creates an AIX® log and a Veritas® file system creates a Veritas® log. The log is then created on the disk specified by the file system (step 406). Once the log is created, the volume manager helper, such as volume manager helper 330 of FIG. 3, is invoked to created opaque data using the information of the file system that issued the log created command and the location of the newly created log (step 408). As the volume manager helper creates the opaque data it associates an opaque identifier to the opaque data (step 410). Finally, the volume manager helper sends the opaque identifier to the file system and the log for use with future requests (step 412), with the operation ending thereafter.

FIG. 5 depicts a flow diagram of a file system requesting access to a log in accordance with an illustrative embodiment. As the operation begins, a request that includes an opaque identifier is received by the logical volume manager, such as logical volume manager 304 of FIG. 3, from a file system, such as file system 302 of FIG. 3, requesting access to a specific log (step 502). The request is parsed and the opaque identifier is sent to the volume manager helper, such as volume manager helper 330 of FIG. 3, to determine the exact location of the log (step 504). The volume manager helper retrieves the location of the log and returns the information to the volume manager helper (step 506). The logical volume manager uses the log location information returned by the volume manager helper to direct the file system to the log (step 508), with the operation ending thereafter.

FIG. 6 depicts a flow diagram of synchronization a log to a file system in accordance with an illustrative embodiment. As the operation begins, a logredo request that includes an opaque identifier is received by the logical volume manager, such as logical volume manager 304 of FIG. 3, to perform synchronization between a log on a logical volume, such as logical volume 310 of FIG. 3, and its respective file system, such as file system 302 of FIG. 3 (step 602). The request is parsed and the opaque identifier is sent to the volume manager helper, such as volume manager helper 330 of FIG. 3, to determine the exact location of the related file system (step 604). The volume manager helper retrieves the location of the file system and returns the information to the volume manager helper (step 606). The logical volume manager uses the file system location information returned by the volume manager helper to direct the logredo request to the file system (step 608), with the operation ending thereafter.

Thus, the illustrative embodiments provide for a simple mapping system for relating information of log locations and files systems to a unique opaque identifier. If a file system or log changes location, the volume manager helper is updated with the latest information, which allows easy access of logs for files systems of files systems for logs. Therefore, the advantage of the illustrative embodiments is to abstract away the relationship of the logical volumes, which allows the file system to support any combination of volume managers without having to write code to specifically support every volume manager combination.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for mapping between a file system and a log, the method comprising:
providing a first volume group, wherein the first volume group comprises a logical volume stored in physical disk locations; and
generating opaque data that identifies a location of the file system and a location of the log within the logical volume, wherein the file system and the log are accessed using the opaque data.

2. The computer implemented method of claim 1, further comprising:
receiving a request from the file system to create the log.

3. The computer implemented method of claim 1, further comprising:
creating the log on the logical volume.

4. The computer implemented method of claim 1, further comprising:
associating an opaque identifier with the opaque data; and
sending the opaque identifier to the file system and the log.

5. The computer implemented method of claim 4, further comprising:
receiving a log access request from the file system, wherein the log access request includes the opaque identifier;
identifying the location of the log using the opaque identifier; and
directing the file system to the location of the log.

6. The computer implemented method of claim 4, further comprising:
receiving a logredo request from the log, wherein the logredo request includes the opaque identifier;
identifying the file system location using the opaque identifier; and
directing the log to the location of the file system.

7. The computer implemented method of claim 1, wherein the logical volume stores multiple file system formats.

8. The computer implemented method of claim 1, wherein the opaque data is stored in a volume manager helper and wherein the volume manager helper is located with at least one of the file system or a logical volume manager.

9. The computer implemented method of claim 1, wherein the opaque data includes at least one of an identifier of the file system and an identifier of the log, or a name of the file system and a name of the log.

10. The computer implemented method of claim 1, wherein the file system resides on a first logical volume having a volume manager of a first type and the external log resides on a second logical volume having a volume manager of a second type.

11. A data processing system comprising:
a volume manager helper;
a file system;
a log; and
a first volume group, wherein the first volume group comprises a logical volume stored in physical disk locations, wherein the volume manager helper generates opaque data that identifies a location of the file system and a location of the log within the logical volume, and wherein the file system and the log are accessed using the opaque data.

12. The data processing system of claim 11, wherein the volume manager helper associates an opaque identifier with the opaque data; and wherein the opaque identifier is sent to the file system and the log.

13. The data processing system of claim 12, wherein the volume manager: receives a log access request from the file system, wherein the log access request includes the opaque identifier; identifies the location of the log using the opaque identifier; and directs the file system to the location of the log.

14. The data processing system of claim 12, wherein the volume manager: receives a logredo request from the log, wherein the logredo request includes the opaque identifier; identifies the file system location using the opaque identifier; and directs the log to the location of the file system.

15. The data processing system of claim 11, wherein the file system resides on a first logical volume having a volume manager of a first type and the external log resides on a second logical volume having a volume manager of a second type.

16. A computer program product comprising:
a computer usable medium including computer usable program code for mapping between a file system and a log, the computer program product including:
computer usable program code for providing a first volume group, wherein the first volume group comprises a logical volume stored in physical disk locations; and
computer usable program code for generating opaque data that identifies a location of the file system and a location of the log within the logical volume, wherein the file system and the log are accessed using the opaque data.

17. The computer program product of claim 16, further including:
computer usable program code for associating an opaque identifier with the opaque data; and
computer usable program code for sending the opaque identifier to the file system and the log.

18. The computer program product of claim 17, further including:
computer usable program code for receiving a log access request from the file system, wherein the log access request includes the opaque identifier;
computer usable program code for identifying the location of the log using the opaque identifier; and
computer usable program code for directing the file system to the location of the log.

19. The computer program product of claim 17, further including:
computer usable program code for receiving a logredo request from the log, wherein the logredo request includes the opaque identifier;
computer usable program code for identifying the file system location using the opaque identifier; and
computer usable program code for directing the log to the location of the file system.

20. The computer program product of claim 16, wherein the file system resides on a first logical volume having a volume manager of a first type and the external log resides on a second logical volume having a volume manager of a second type.
